(19) United States
(12) Patent Application Publication
(10) Pub. No.: US 2009/0219291 A1
(43) Pub. Date: Sep. 3, 2009

(54) MOVIE ANIMATION SYSTEMS

(76) Inventors: David Brian Lloyd, Cambridge (GB); Matthew David Kelland, Cambridge (GB)

Correspondence Address: Clise International IP LLC, 3209 West 76th Street, Suite 205, Edina, MN, 55435, US

(21) Appl. No.: 12/395,396

(22) Filed: Feb. 27, 2009

Related U.S. Application Data
(60) Provisional application No. 61/032,832, filed on Feb. 29, 2008.

(51) Int. Cl. G06T 15/20

(52) U.S. Cl. 345/427

(57) ABSTRACT

This invention relates generally to methods, apparatus, and computer program code for machine-assisted generation of animated films/movies, in particular for animation based on games engine technology. We describe methods of controlling a plurality of virtual cameras in a 3D virtual reality environment, and also methods of controlling a plurality of animated characters and objects within the 3D virtual reality environment. These enable a director controlling said environment to create a movie of a story set within the environment We also describe methods of providing random time access to a scripted animation with many scripted activities and controlled-random performance activities, techniques for automatically controlling camera framing, and techniques for automatically controlling the gaze direction of animated characters within the movie.

### FIELD OF THE INVENTION

This invention relates generally to methods, apparatus, and computer program code for machine-assisted generation of animated films/movies, in particular for animation based on games engine technology.

### BACKGROUND TO THE INVENTION

Techniques, called Machinima, are used to create animated film/movie sequences (in this specification “film” and “movie” are used interchangeably), using games engine technology. It is desirable to facilitate the creation of such animation without the need for high level movie-directing skills.

### SUMMARY OF THE INVENTION

According to a first aspect of the invention there is therefore provided a method of controlling a virtual camera position in a 3D virtual reality environment to enable a director controlling said environment to create a movie of a story set within said environment, the method comprising: selecting a subject in said environment; defining a framing line on said subject; and wherein said framing line defines an image of said subject captured by said virtual camera and determines a position of said virtual camera relative to said subject, such that as said subject moves within said environment, said virtual camera moves with said subject so as to maintain substantially the same image of said subject captured by said virtual camera.

The framing line may define a long shot or a close-up shot of the subject. In some preferred embodiments one or both of the subject and the framing line are determined automatically, in response to a determined level of interest for the subject (an “interesometer”). In embodiments this level of interest is determined using a script for one or more subjects of the movie; in embodiments such a script may be at least part automatically determined, for example to add improvised actions to a character. The script defines actions of the subject, and these may be categorised and allocated weights for use in determining a level of interest; these weights may be time-dependent Examples of such categories include the interaction of a character with an inanimate object, the interaction of one character with another (generally given a high weight), the reaction of one character to another (a “reaction shot”), and the performance of an action by a character or an improvised action by the character. In one example ordering of the weights, the interactions of a lead actor are given preference, then followed by any speaking character, a reaction shot, and then, with a lower weight, other character actions. In embodiments the initiation of an action may set a weight which then decays over time. Employing decaying weights helps to provide a changing focus of interest, which is useful.

Such an approach enables the software to determine what is the latest most interesting character/object Once a latest focus of interest has been determined a suitable camera can be identified, for example by identifying whether an existing camera can already see the focus of interest or, if not, by identifying a camera to be moved to view the focus of interest, resulting in a cut With fast-paced action a maximum and/or minimum number of cuts per second may be specified to provide parameters within which the automatic control operates. In embodiments selection of a camera view may also be made from amongst a group of different views, optionally selected according to the type of focus of interest, for example an intimate or close shot, a long shot and the like.

In embodiments of the method a user (“director”) is able to modify the positions of the virtual cameras, type of shot, focus of interest, cuts and the like but in many cases the automatic procedure suffices, or suffices at least to provide a starting point for modification.

In a related aspect the invention provides a method of controlling a virtual camera position in a 3D virtual reality environment to enable a director controlling said environment to create a movie of a story set within said environment, the method comprising: selecting a subject in said environment; defining a first framing line on said subject, said first framing line defining a first image of said subject captured by said virtual camera and determining a first position of said virtual camera relative to said subject; defining a second framing line on said subject, said second framing line defining a second image of said subject captured by said virtual camera and determining a second position of said virtual camera relative to said subject whereby as said subject moves within said environment, said virtual camera interpolates from said first virtual camera position to said second virtual camera position so as to smoothly transform from said first image of said subject to said second image of said subject.

In embodiments of the method the first framing line defines a long shot of the subject, and the second a close-up of the subject so that, as the subject moves, the camera zooms in on the subject.

In a further related aspect the invention provides a method of controlling a plurality of virtual cameras in a 3D virtual reality environment to enable a director controlling said environment to create a movie of a story set within said environment, the method comprising: defining a plurality of animated characters and objects within said environment; positioning said plurality of virtual cameras to provide a plurality of different images of said characters and objects within said environment; providing a script, said script defining activities enacted by said characters with said objects; allocating an interest value to each of said activities defined in the script; running said script; determining, as said script runs, which of said virtual cameras provides an image of the activity in the script with the highest interest value; automatically cutting to said virtual camera providing an image of the activity in the script with the highest interest value; and outputting said images of activities with the highest interest value on an output device to create said movie.

It will be appreciated that, from the point of view of the software, the plurality of virtual cameras may comprise a single-time multiplexed camera which changes position/angle to change shot, although to the director this is (preferably) presented as a plurality of “logical” virtual cameras, again to make the software easy to use from the point of view of a novice.

In embodiments of the method the length of time the image from each virtual camera is used is monitored and the procedure automatically cuts from one image to another when this time exceeds a (predetermined) threshold This threshold may be set by the director to determine a number of cuts per second. The number of cuts per second may be set responsive to or independently of a decay of a level of interest of a focus of interest over time.

In embodiments of the above-described methods, because in preferred implementations a games engine may be employed to generate the action, occasionally physically impossible processes may appear to take place, for example an object may appear to teleport between two positions. Thus preferred embodiments of the method incorporate a notion of “badness”, in particular by assigning a penalty value to part of an activity in a script which results in an inconsistency in an image of the activity. One or more virtual cameras providing an image of the penalised part of the activity may then be identified and an automatic cut to an image from another of the virtual cameras which does not provide an image of the penalised inconsistency may be made.

In some preferred embodiments characters and/or objects within a 3D virtual environment are implemented using state machines, each character/object having its own state machine—for example, an object may be in a state of being held or a telephone may be in a state of ringing or not ringing, and so forth.

In this way it can be determined from the state machine when a discrete jump has been made between states without proper intervening animation.

In some preferred embodiments of the methods we describe the positioning of a camera is determined by “cinematic grammar”, that is by (simple) rules which may be employed so that activities or moods can suggest cameras to employ. For example if a script determines that, say, a conversation is taking place then a corresponding cinematic rule may define two relatively close camera positions, each looking roughly directly at one character over the shoulder of the other. It will be understood by those skilled in the art that there are many such cinematic conventions which may be employed, programmed into the cinematic grammar rules for locating and/controlling camera positions. In a similar way, camera rules can be included and selected based upon mood either of one or more characters or of an entire scene. For example a character scripted or identified as dominant may be viewed by a camera looking up towards the actor whereas a character scripted as submissive may be viewed by a camera looking down on the character/actor.

In a related aspect the invention provides a method of controlling the direction of gaze of an animated character in a 3D virtual reality environment to enable a director controlling said environment to create a movie of a story set within said environment, the method comprising: defining a plurality of animated characters and objects within said environment; positioning at least one virtual camera to provide an image of said characters and objects within said environment; providing a script, said script-defining activities enacted by said characters with said objects; allocating an interest value to each of said activities defined in the script; running said script; determining, as said script runs, which one or more of said activities had a highest said interest value; and controlling the gaze of one or more of said animated characters to direct their gaze towards said one or more activities with said highest interest value as said script runs.

Preferably the method includes a habituation process to decay a said interest value over time of an activity towards which said character gaze is diverted such that a relative interest of said activity compared to others of said activities decreases over time. In embodiments activities with a higher interest value than other activities include talking, such that as characters speak in turn said gaze of one or more others of said characters is directed correspondingly in turn towards the said speaking character.

In another aspect the invention provides a method of controlling a plurality of animated characters and objects within a 3D virtual reality environment to enable a director controlling said environment to create a movie of a story set within said environment, the method comprising: representing each said character and at least one of said objects using a respective state machine, each state machine being a state representing a physical configuration of a said character or a said object; providing a script, said script defining activities enacted by each of said characters with at least one of said objects; controlling said state machines using said script; and representing said characters and said objects on an output device by representing states of said state machine.

In embodiments the script may have a plurality of tracks, in particular including a first track representing activities determined by the director and a second, performance track to automatically add quasi-random physical motion to die characters. Preferably then inconsistencies between activities in the director's track and the quasi-random motion are identified and the motion adjusted to inhibit such inconsistencies. In embodiments this resolution of inconsistencies is performed by a said state machine: for example if a part, say a hand, of the character is needed for an action but is already holding a mug then a portion of the script controlling the state machine for the character can be automatically rewritten to use the other hand for the mug.

In preferred embodiments the state machine for a character comprises a multi-threaded state machine, each thread defining actions for a part of the character, each state of the multi-threaded state machine comprising a pose of that part of the character, animation then transitioning between these states. In this way one character may have a plurality of action threads and is thus enabled to, for example, sit/walk, and talk, and manipulate an object in one or both hands all substantially simultaneously.

In embodiments of the method one or more of the activities contains one or more sub-activities nested within the activity, the activities and sub-activities being stored in a nested set of hierarchical data containers. In embodiments these data containers comprise time-referenced data items, in particular defining states of an aforementioned state machine, and when animating a character these data items are processed in strict time order irrespective of a hierarchy of a data container holding the data item—that is the container does not mask the time order. This in turn enables essentially random access to the animation, although when jumping to a point within a container preferably animation is then delegated to the container (which may perform interpolation, for example to repair an imperfect animation). In embodiments an action in a main sequence of the script may be performed or executed earlier than one in a container.

One advantage of the techniques we are describing is that the movie timeline may be “scrubbable”, that is providing random time access to the timeline. This may be implemented by playing the animation forwards from a known state; such a known state may be identified, for example, by identifying end states of animations within a container—for example the end state of a container of a sit-down action may be a sat-down state. When determining such an end state in the context of nested containers there may be delegation to the most general container.

Thus in a further aspect the invention provides a method of providing random time access to a scripted animation, said animation being defined by animation of between configurations of characters and objects each defined by a state of a state machine, the method comprising identifying a defined state of said animation at a time prior to a random access time and then playing said animation forward from said prior time to said random access time.

The skilled person will understand that because, as previously described, some of the actions of characters are quasi-random the precise animation is, in embodiments, not exactly repeatable, bat is repeatable in so far as required by the script.

In preferred methods we describe the director is able to define a series of goals for one or more of the characters so that the movie may at least in part be generated by stepwise solving of this series of goals. For example a goal-based activity may comprise an activity such as place object A on object B, switch a light on or off, go to the other side of a wall, and the like. Some of this goal-directed activity may comprise simple AI (artificial intelligence) routines, for example a route-finding routine. One advantage of being able to define goals in the context of an automatic movie animation system is mat it provides ease and flexibility of use, for example facilitating re-ordering of elements of a scene.

To further simplify use of the software preferably the method includes identifying inconsistencies between the physical configuration of the characters and the objects and/or goals which are in conflict with one another—for example requiring a character to both sit and depart Such inconsistencies may be flagged up to the user for resolution and/or automatically resolved by attempting to identify solutions to the goals which remove the inconsistencies.

In embodiments a goal planner module is included which stores goals on a stack and reads the stack of goals, starting with the earliest In this way errors may be resolved, for example, by giving an earlier goal priority. Additionally or alternatively the user (director) may be provided with a “to do” panel listing inconsistencies to resolve, in embodiments providing an optional “fix like this” suggestion. This may use the priority-based approach described above and/or an approach based on minimum modification to a character's pose.

In preferred embodiments the user is able to define goals as described above and these, in turn generate scripts defining activities for the characters, including lower level activities. Such a script may include both goal-based and non-goal based activities (an example of the latter might be an explicit movement of a character to turn on a light). As previously mentioned, in preferred embodiments the system adds random motion to a character, for example as a separate “performance track”.

Thus the invention further provides computer program code to implement embodiments of the method. The code is provided on a physical carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

The invention further provides a general purpose computer system programmed to implement embodiments of the above-described method. Such a computer system will generally include a processor, working memory, programme memory storing software to implement the automatic movie generation system, a display preferably driven by a hardware accelerator, low-level games engine code (many such engines are available and may be employed), and a range of user input devices including, but not limited to, a keyboard, mouse, trackball or joystick, tablet and the like. Preferably such a computer system also includes a network connection, for connection to a local or wide area network and/or the Internet. To enable multiple users to exchange animations and/or work collaboratively with characters, animations, movie segments and the like.

In embodiments of the system the script of the movie may also be used to generate data for a three-dimensional movie editor, that is a movie editing system which enables editing within a three-dimensional virtual environment defined by the movie. This may be implemented, for example, by providing a “green screen” function somewhat analogous to the green screen used for real life films. In embodiments this may be incorporated by omitting to render a background portion of the 3D scene and instead providing a green background, for example as a green screen colour plane. This green screen function may then be employed to add alternative backgrounds, in particular 3D models, for example of Wall Street if, say, it is desired that the character walks down Wall Street. Tins three-dimensional information may be given a scene hierarchy defining it as background. Such an arrangement also facilitates other functions such as a cross-fade in which, for example, the background changes whilst a character remains, eventually seeming to transfer to a different, new environment.

In embodiments the script may be employed to produce a cinematic-type edit track which operates for the movie analogously to the way in which a page layout operates for a page of text, defining a framework in which the movie action take place. In embodiments the information content of the movie may be encapsulated by the movie script or more precisely a set of scripts, which may then be played on different game engines depending upon the actual computer system implementing the software. In embodiments the script is implemented in XML, for convenience. The script includes a data hierarchy with scripted actions for one or more characters and/or objects, and, preferably a separate camera track. In this way realistic camera functions such as lens flare or even dirt and the like may be added for improved realism.

### BRIEF DESCRIPTION OF THE DRAWINGS

These and other aspects of the invention will now be further described, by way of example only, with reference to the accompanying figures in which:

FIG. 1 shows a hierarchical data structure for defining a movie as a document or script according to an embodiment of the invention;

FIG. 2 shows an extract of a more detailed example of a Thing super class of entities that make up a movie;

FIG. 2 shows a timeline (time increasing to the right) illustrating scripted activities of a main character together with a corresponding performance track, and schematically illustrating rendering and sound processes associated with the movie;

FIG. 4 shows, schematically, a set of nested data containers storing a hierarchical nested set of activities, illustrating start and end points of the containers in time for implementing timeline scrubbing according to an embodiment of the invention;

FIG. 5 shows an example of execution of a movie data structure comprising data components for a script defining scripted activities, and performance activities;

FIG. 6 shows a block diagram of an automatic movie animation system according to an embodiment of the invention; and

FIGS. 7a and 7b show, respectively, an example of framing lines defining two character targets, and an example of a pair of framing lines defining the same character target.

### DETAILED DESCRIPTION OF PREFERRED EMBODIMENTS

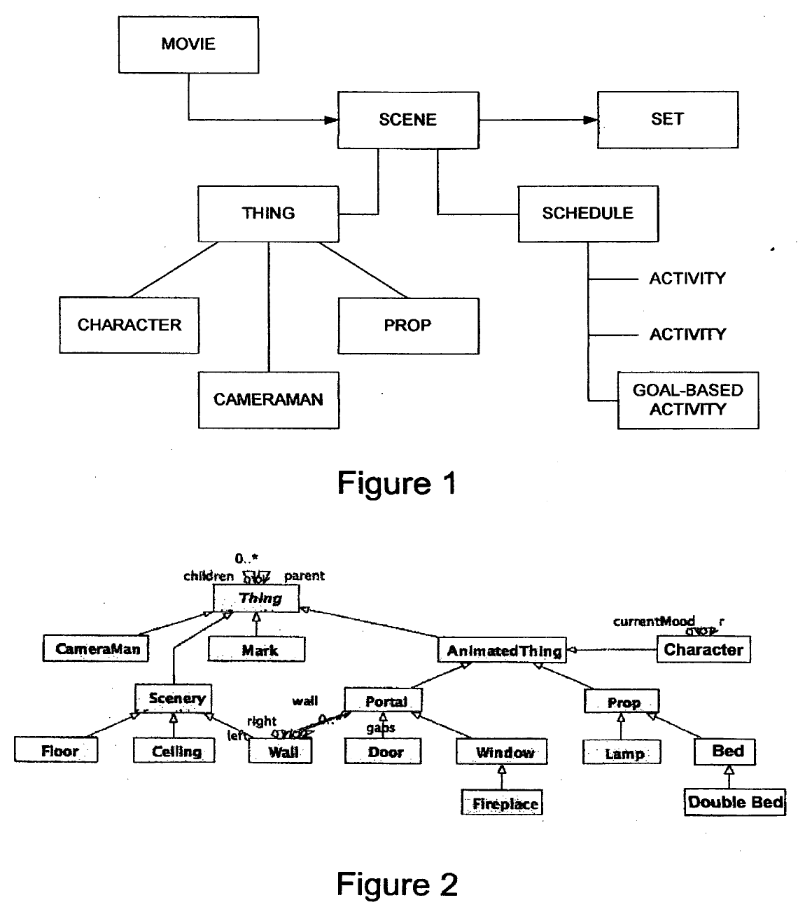

Referring to FIG. 1, this shows a simplified object hierarchy for entities of a movie. In embodiments the movie structure comprises a complete persistent dataset describing the movie as a document that is serialised, and deserialised using Xstream (registered trade mark). Xstream gives a human readable XML file and is robust to an evolving schema. The Movie class is the top level container for everything describing a movie. The Movie holds the cast of all Characters who appear in the movie and the list of all Scenes that comprise the movie. It also holds general information about the movie including the director name, tagline, synopsis and outline.

The Scene class describes everything that happens in a scene in a movie. It does this via the Schedule class which Is a time ordered list of Activities. The Schedule is quite a special class and supports a variety of insertion, deletion, and search operations and is the key to scrubbing along the timeline. The Schedule of Activities if informally known as the Script.

The Scene also contains the Set (or Location) where the action takes place. It can do this by inclusion or reference, but the current behaviour is inclusion so each Scene has its own copy of the Set. It also holds general notes about the scene for the benefit of the scriptwriter.

The set may be a simple description: For example the floor may be a simple 50 m square plane where each 1 m square tile can be painted with its own material. The ceiling may be a similar plane 3 m above the floor where tiles can additionally be invisible where there is no ceiling desired.

All other items on the set are variants of Scenery Items and the Set contains a simple unordered list of these. Walls and Portals within Walls are treated specially by the Set Workshop but are otherwise represented the same as all other Props (static or animated models). Subclasses of Props such as Lamps provide additional behaviour within the Set.

Simple sets go a long way and the three-walled set is actually very useful for filming a variety of scenes. However sets may be improved to allow more varied and interesting scenes, e.g. with non-flat floors: both smoothly varying terrains and stepped changes in height for stairs, daises, kerbs, etc. A portal based system may also be used. This allows separate areas or rooms with distinct geometries, connected via portals (or render windows) giving sets with complex topologies (floors above each other, interiors connected to exteriors, etc.)

Embodiments can provide an easy mechanism for users to build and design such sets. One way of achieving this Is to provide a variety of shell geometries that users ban paint and dress and make simple modifications to (such as erecting additional walls).

In embodiments the Thing is the superclass of all entities that make up a movie. Things are a high level persistent abstraction independent of the render scenegraph. They are the nouns, subjects and objects, of sentences in the script. An example is shown in FIG. 2.

All Things have a textual name and can have a specific importance (how significant is this thing in the movie) and interest level (how interesting is this thing and what its doing at the current time “interesometer”). For example a speaking character is allocated a high interest level; other activities and physical items, for example a weapon, may be also be allocated a high interest level. In preferred implementations the interest level is decayed over time, to allow a character gaze to shift (“habituation”).

When Things are setup on a Scene, any visual components (3D models, etc) are attached to the Scenegraph. The top level SceneObject representing a Thing can then be obtained. When changing between Scenes, Things are similarly torn down.

When scrubbing along the timeline, any transient state within a Thing is reset Things advertise verbs so that users can issue commands involving those Things. The Thing hierarchy is fairly shallow as much of the specific behaviour comes from descriptions attached to the raw assets.

Referring to FIG. 2, AnimatedThing is the superclass for most Things that use a Puppet (optionally animated) as the basic 3D representation. Character is the principal class for actors in the Scene. Characters appear on Marks and move from Mark to Mark. CameraMan is the principal class for controlling our cameras in the Scene. Scenery is the superclass for Things that are just static parts of the Set and which are not directly interacted with. Portal is the superclass for Things mat can be obtained within a Wall.

In this hierarchy Props and Portals are subclasses of AnimatedThing not Scenery. We also do not make a distinction between Set Dressing (things placed around the set) whether or no they can be interacted with and Props in the theatrical sense of things that can be held and utilised.

Activities

Activities describe everything mat can happen on the timeline. They are the vocabulary of the script All Activities have a subject which is the principal Thing this activity applies to. Subclasses may reference other Things where needed (for example, a MutualAnim references the other participants). To this end the isInvolved method reports whether or not a Thing is referenced by an Activity.

All Activities have a start time and a stop time and by implication a duration (although different subclasses are in fact free to choice which of the duration or stop time is definitive but they must be consistent). Instantaneous Activities simply have a duration of zero.

The primary purpose of an Activity is to drive the behaviour of Things in the Scene as the timeline is played or scrubbed and specific subclasses of Activity should implement start, stop and update to achieve this.

Like Things, Activities are set up when we start working on a Scene and torn down afterwards. This allows an activity to Include 3D representations (e.g., foot plants) and manage other resources (e.g., audio). Activities can perform clean up operations when removed from the Schedule (and there is a corresponding unremove to handle undo operations).

Activities can supply a visual component for their representation on the timeline (the Label). Activities are typically represented on the timeline by a coloured bar that stretches from the start time to the stop time, but an Activity has complete freedom provide a Label that represents it however desired (e.g., it might have an icon). Activities can be dragged or resized (at their choice) on the timeline via their Label.

Activities can also provide popup menu actions when clicked upon and there is a standard customize action that provides a CustomizerPanel in a frame above the timeline.

Basic Activities

Most elemental activities are derived from BasicActivity: a convenience implementation of Activity which has a predefined start time and duration.

Activity Containers

Activities can contain other activities nested within them. All timings for nested activities are relative to their parent container. Methods are provided to get the global timings when needed by following up the parent references.

The ActivityContainer provides a general purpose container with its own Schedule. Special case constructors are provided for open ended activity containers which runs until the end of the scene.

Some containers provide additional management of their nested activities. For example the MasterAnimSequence container holds the position, orientation and base pose between activities avoiding jumps.

The top level containers may informally be referred to as tracks.

Preferably the scrubbing procedure handles parallel nested activities so that container managed animation is not necessary (but the ability of the container to look ahead within its own schedule can still be a useful tactic for smoothing animations).

Another common pattern is for an activity which wraps a single activity and modifies it in some way (e.g., Time Warp plays its child activity at a different timerate).

Scripted Activities

All activities that are generated as a result of user input and are recorded in the persistent Script are informally known as Scripted Activities. They are not discriminated by any particular class and conversely some Activity classes appear in both the Script and the Performance.

Performance Activities

Activities that are generated by the planning process as implementation of die Script are informally known as Performance Activities. These are transient and recreated every time we enter the Scene. The Performance need not be precisely the same allowing some random variation during retake but the user can fix the performance by freezing the random seed. For convenience, the performance activities are grouped into a performance track for each active Thing.

In preferred implementations a character is enabled to follow dialog, turning their head from side to side, rather in the manner of watching a ball in a tennis match. This can be achieved by controlling the direction of gaze of a character according to the “interesometer”. More particularly, however, in a scene defined by a script there will be multiple activities with different interest levels, and in embodiments the system identifies one or more activities with a highest interest level, which will in general be (chosen to be) a speaking character, and directs the gaze towards that activity or those activities. Habituation provides a more lifelike appearance to the replayed movie, allowing a character to shift gaze rather than remaining locked onto a single activity, even if that activity initially had a high interest value.

Scrubbing along the Timeline

Scrubbing is a useful feature for Moviestorm's operation. The aim is that when we scrub the timeline to a particular moment in time, what we see on set and what we see on set and what we see through the camera is as expected.

The procedure to scrub to a particular time is as follows:
1. Reset the internal states of every Thing in the Scene.
2. Scan along all the Activities in the Schedule and, in strict time order, apply the start and stop events.
   Note: this applies equally to Activities nested in parallel containers. Events on the same time are applied in nesting order (in then out).
3. Activities for which are active at the target time, also have the update method applied.

The abstract behaviours for the events are:
start sets up the initial state for an activity: transforms, animation state machine, etc.
stop sets up the final state as successor events would expect to see it update sets the detailed state for the target time within the activity: transforms, animators, and any other time varying properties of the Things in the Scene.

The start and stop events are preferably strictly repeatable but the update method is allowed some latitude as long as it is consistent at the start and end points. For example, a particle system is only approximately repeatable but this does not matter as long as there are no visual jumps between Activities.

Typically, the start and stop events are as lightweight as possible since to scrub to a particular time we must trigger all start and stop events from the start of the scene up to the target time.

Realtime playback may be implemented as a special case of scrubbing optionally with some additional rules for, for example, playing sound.

A refinement of the scrubbing algorithm is to exploit temporal coherence between the time previously scrubbed to and the target time, but this is not particularly important issue since scrubbing can occur between fairly random moments and it is preferable to have smooth behaviour regardless.

Verbs and Goats

Verbs that generate Goals should preferably use preconditions of the Goal to determine applicability rather than encode the logic inside the verb. This aims to ensure that if conditions prior to the activity change (as a result of user edits) the Goal is able to detect this and correctly raise a flag with an Advisor Function.

Goals give the script some flexibility; they respond well to script changes: either by finding a different solution to satisfy the director's instruction or by flagging an error when the preconditions cannot be met. Goals should be used by first preference and verbs should preferably only script direct activities when there is no agent to control. Explicit wrapping of a goal with RoutePlanningGoal should not be necessary as this may be treated as a rule not a goal.

Planning and Retake

The planning process (retake) runs through the Scripted Activities and generates the Performance by stepwise solving Goals. Goals typically involve steering Characters around the Set but can also navigate through the State Machine.

Planning occurs every time we enter a scene and every time die user retakes a scene. Retakes also occur as a result of significant changes to the Script such as activities being added or removed, activities being moved in time and most customisation operations on activities.

Planning is basically a special case of Playback where we scan through the entire scene but can skip from decision point to decision point.

At each decision point retake should be quite quick but can be more expensive than scrubbing. Nevertheless only a limited subset of the Scene's state is simulated whilst planning and preferably therefore rules are used that need only rely on the position, orientation and animation states of the Things in the Scene. Specifically, in embodiments the skeleton configuration of puppets is computed on demand and this is therefore to be avoided wherever possible.

If the decision points are not clear cut it may be preferable to scrub both the Script and the Performance.

Script

Referring now to FIG. 3, this shows an example of a script for scripted activities, “stand here”, “go to X”, “sit down” and, as schematically illustrated, this feeds into a goal planning process which defines the lower, performance track, showing low level actions of the character, for example “step L[EFT]”, “step R[IGHT]” for “go to X”. The cursor shows a current time and the small triangle at the base of the cursor indicates a camera which is viewing the scene, by defining a framing line as described earlier.

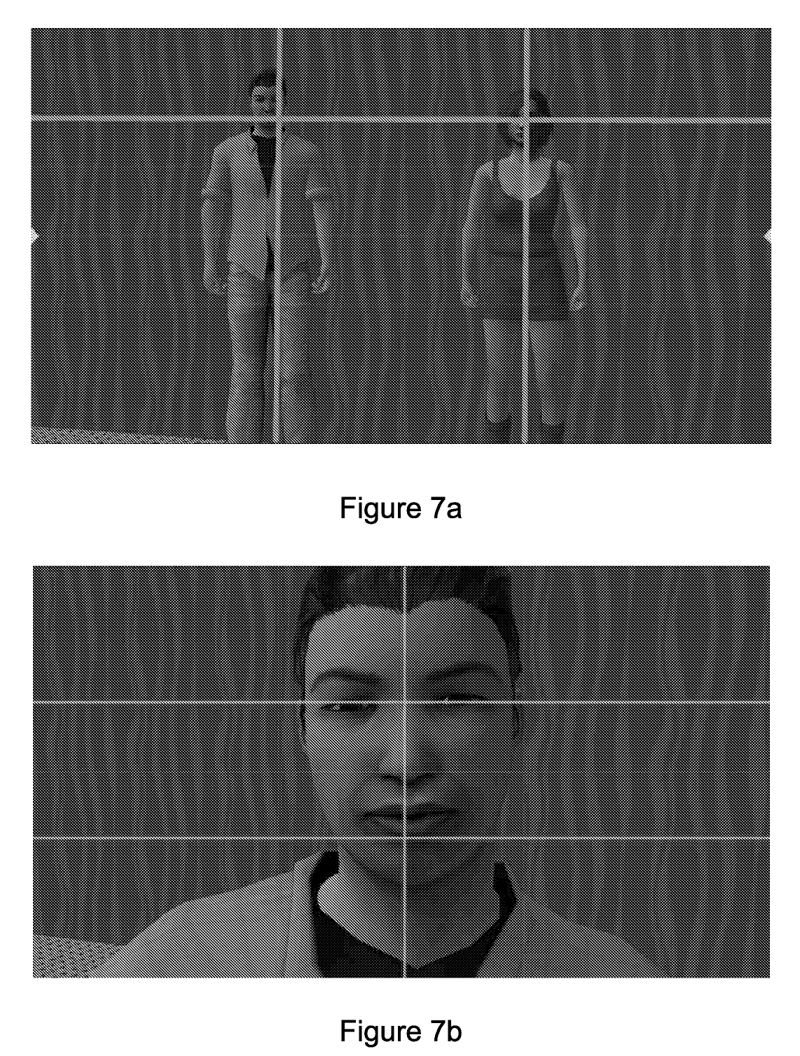

Preferred embodiments of the method do not employ “dolly paths” but instead use framing lines onto an object to define a view, as illustrated in FIG. 7a. In this way when an object is moved the camera moves automatically with the target—the user (director) does not need to know and may not care where the camera is since the camera AI operates by defining one or more targets and then automatically panning. The user may, nonetheless, be provided with camera controls for example to define a long shot close-up or the like. This approach facilitates interpolation of camera framing, for example to maintain a close-up of a character walking or moving irregularly. It will be appreciated that with this approach it is straightforward to define that the camera follow a particular motion and, for example, gradually change the zoom onto a target, a procedure which would otherwise be very difficult. Similarly by defining a pair of framing lines ending on the same target, for example as shown in FIG. 7b, it is straightforward to hand over from one camera to another.

Data Containers

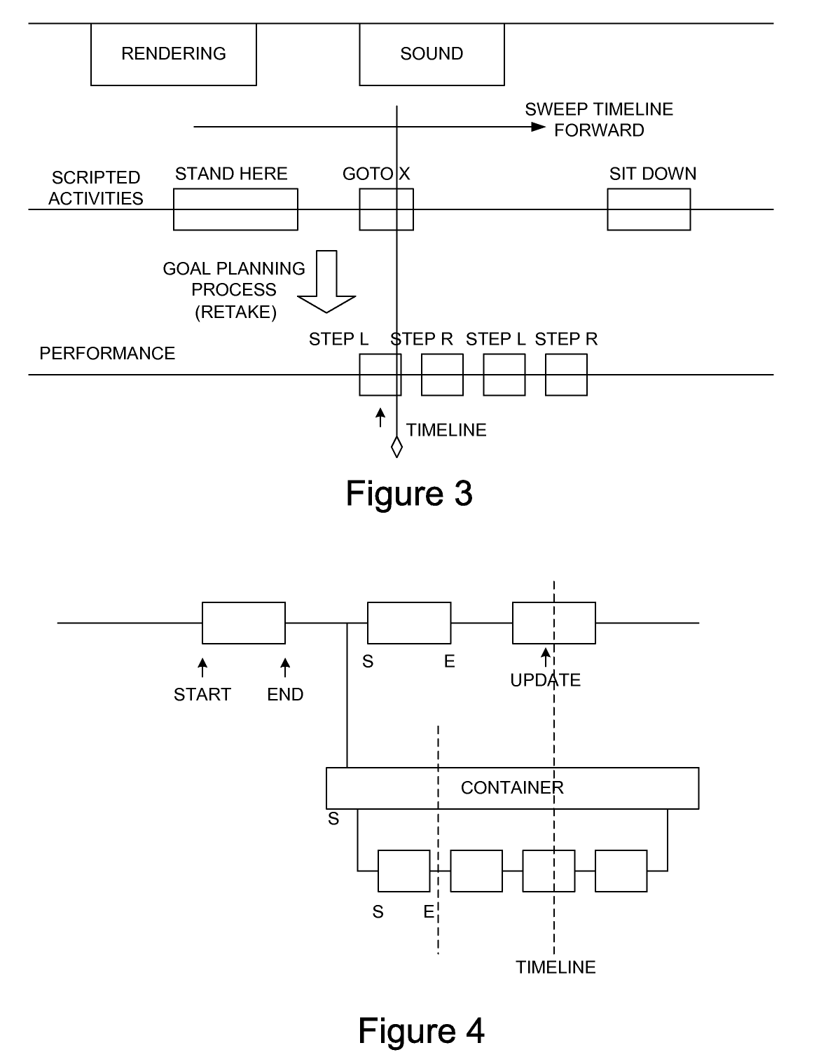

Referring now to FIG. 4, this shows in more detail an example of a hierarchical nesting of containers along a timeline (time increasing linearly to the right). The containers define activities and nested sub-activities; as can be seen from the gaps in the timelines, some of these activities have gaps between them. The labels “S” and “E” refer to start and end points of the activities defined within the containers, and hence to defined states of state machines representing the objects or characters which are the subject of the activities. When the activities are being interpreted to control the characters/objects time runs strictly, that is the time of activities even with nested sub-containers is determined by the absolute time along the timeline (as schematically illustrated by the left vertical dashed line). At intervals a state of an object within a container or nested sub-container may update another object, as shown schematically by the “update” arrow. This approach facilitates scrubbing along the timeline by working forward from a known state, in particular the end state of a container or nested sub-container although as schematically illustrated, in the case of nested sub-containers, this process may be delegated to a holding container.

In a refinement of the above-described techniques, camera key frames may be employed, in particular where there are multiple (virtual) cameras, to define particular shots on particular characters. In this way a list of shots on named characters may be defined to provide a high level description of activities within the movie (“cut to A”, “cut to B”, and so forth). This may serve as an overview for the movie.

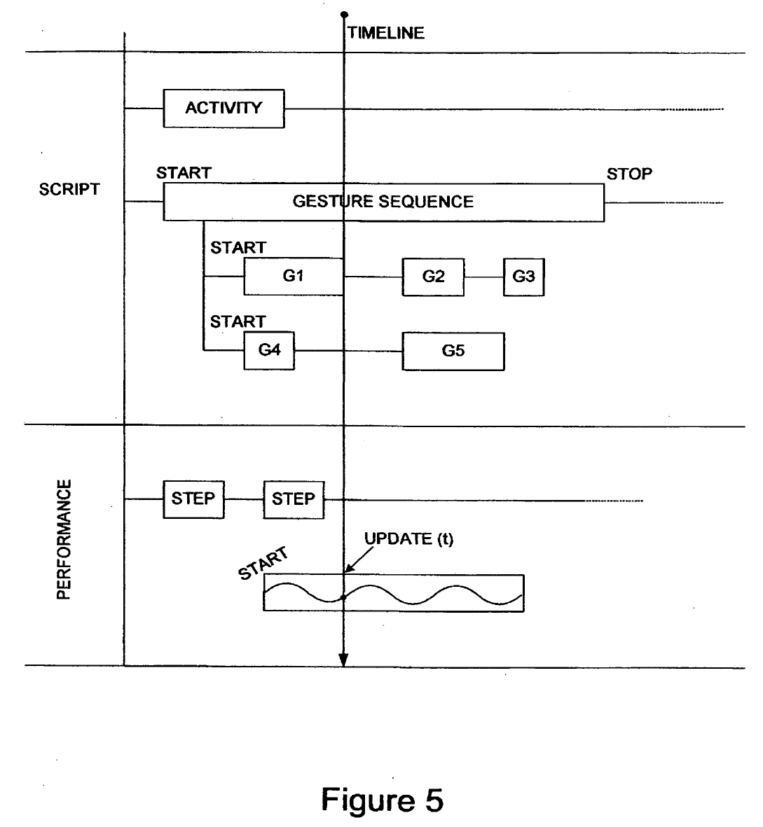

Referring to FIG. 5, this shows an example of execution of a movie data structure comprising data components for a script defining scripted activities and performance activities. This example further illustrates that according to the best mode of implementing the invention every data item in the script and performance tracks has a notional start and stop event Some objects, for example the illustrated gesture sequence, have a container-based or nested hierarchy as described above. In the example two sequences of gestures, G1, G2, G3 and G4, G5 run in parallel; in general a plurality of sequences of actions within a container may run in parallel. In the performance track walking is represented by alternate Step (Left) and Step (Right) items.

To execute the movie defined by the movie data structure the Timeline arrow sweeps forward and executes the start and stop events regardless of the hierarchy. If the Timeline arrow crosses a box (data item) a specific update is performed. This is illustrated by the simple cycling animation with Update(t)—the system calls Start, and then calls Update(t) which sets the animation controller to the right point. In this way execution of the movie proceeds in a controlled and synchronised manner. This approach also enables controllable random access to a point in the movie, ensuring that the scripted and performance activities are at the correct, desired point in time and properly synchronised (recalling that performance activities need not be precisely the same each performance unless, for example, the user fixes the performance by freezing a random seed used for controlling a performance activity).

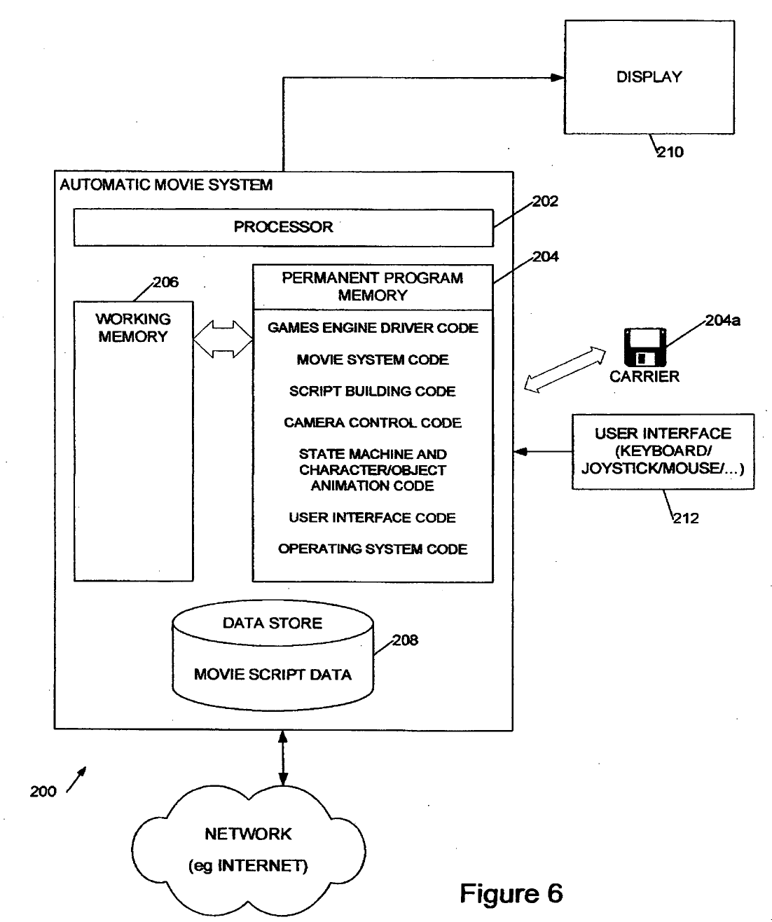

Referring now to FIG. 6, this shows a schematic block diagram of an automatic movie system 200 comprising a processor 202, working memory 206, a store of movie script data 208 as described above, and permanent program memory 204 storing: games engine driver code, movie system code including script building code, camera control code, state machine and character/object animation code, user interface code, and an operating system. Some or all of the movie system code may be provided on a data carrier 204a, illustratively shown by a disc. The system 200 also has a display 210, a user interface 212, and an internet connection.

No doubt many other effective alternatives will occur to the skilled person. It will be understood that the Invention is not limited to the described embodiments and encompasses modifications apparent to those skilled in the art lying within the spirit and scope of the claims appended hereto.

1. A method of controlling a virtual camera position in a 3D virtual reality environment to enable a director controlling said environment to create a movie of a story set within said environment, the method comprising:
selecting a subject in said environment;
defining a framing line on said subject; and
wherein said framing line defines an image of said subject captured by said virtual camera and determines a position of said virtual camera relative to said subject, such that as said subject moves within said environment, said virtual camera moves with said subject so as to maintain substantially the same image of said subject captured by said virtual camera.

2. A method according to claim 1, wherein said framing line defines a long shot or a close-up shot of said subject.

3. A method as claimed in claim 1 wherein one or both of said subject and said framing line is determined automatically in response to a determined level of interest for said subject.

4. A method as claimed in claim 3 further comprising determining said level of interest in response to a script for said subject, said script defining actions performed by said subject.

5-6. (canceled)

7. A method of controlling a virtual camera position in a 3D virtual reality environment to enable a director controlling said environment to create a movie of a story set within said environment, the method comprising:
selecting a subject in said environment;
defining a first framing line on said subject, said first framing line defining a first image of said subject captured by said virtual camera and determining a first position of said virtual camera relative to said subject;
defining a second framing line on said subject, said second framing line defining a second image of said subject captured by said virtual camera and determining a second position of said virtual camera relative to said subject whereby as said subject moves within said environment, said virtual camera interpolates from said first virtual camera position to said second virtual camera position so as to smoothly transform from said first image of said subject to said second image of said subject

8. A method as claimed in claim 7 wherein said first framing line defines a long shot of said subject and said second framing line defines a close-up shot of said subject whereby as said subject moves, said camera zooms in on the subject.

9. A method as claimed in claim 7 wherein one or both of said subject and said framing line is determined automatically in response to a determined level of interest for said subject.

10. A method as claimed in claim 9 further comprising determining said level of interest in response to a script for said subject said script defining actions performed by said subject.

11-12. (canceled)

13. A method of controlling a plurality of virtual cameras in a 3D virtual reality environment to enable a director controlling said environment to create a movie of a story set within said environment the method comprising:
defining a plurality of animated characters and objects within said environment
positioning said plurality of virtual cameras to provide a plurality of different images of said characters and objects within said environment;
providing a script, said script defining activities enacted by said characters with said objects;
allocating an interest value to each of said activities defined in the script; running said script;
determining, as said script runs, which of said virtual cameras provides an image of the activity in the script with the highest interest value;
automatically cutting to said virtual camera providing an image of the activity in the script with the highest interest value; and
outputting said images of activities with the highest interest value on an output device to create said movie.

14. A method according to claim 13, comprising monitoring the length of time the image from each virtual camera is outputted to the output device and automatically cutting to an image from another of said virtual cameras when said monitored length of time exceeds a threshold.

15. A method according to claim 14, wherein the director is able to set the threshold to determine a number of cuts per second.

16. A method according to claim 13, comprising assigning a penalty value to any part of each of said activities in said script which results in an inconsistency in said image of said activity, determining which of said virtual cameras provides an image of said penalised part of said activity and automatically cutting to an image from another of said virtual cameras which does not provide an image of said penalised part.

17. A method according to claim 13, wherein the positioning of said plurality of virtual cameras is determined by cinematic grammar rules.

18-19. (canceled)

20. A method of controlling the direction of gaze of an animated character in a 3D virtual reality environment to enable a director controlling said environment to create a movie of a story set within said environment, the method comprising:
defining a plurality of animated characters and objects within said environment;
positioning at least one virtual camera to provide an image of said characters and objects within said environment;
providing a script, said script-defining activities enacted by said characters with said objects;
allocating an interest value to each of said activities defined in the script;
running said script;
determining, as said script runs, which one or more of said activities had a highest said interest value; and
controlling the gaze of one or more of said animated characters to direct their gaze towards said one or more activities with said highest interest value as said script runs.

21. A method according to claim 20 further comprising a habituation process to decay a said interest value over time of an activity towards which said character gaze is diverted such that a relative interest of said activity compared to others of said activities decreases over time.

22. A method according to claim 20 wherein activities with a higher interest value than other activities include talking, such that as characters speak in turn said gaze of one or more others of said characters is directed correspondingly in turn towards the said speaking character.

23-24. (canceled)

25. A method of controlling a plurality of animated characters and objects within a 3D virtual reality environment to enable a director controlling said environment to create a movie of a story set within said environment, the method comprising:
representing each said character and at least one of said objects using a respective state machine, each state machine being a state representing a physical configuration of a said character or a said object;
providing a script, said script-defining activities enacted by each of said characters with at least one of said objects;
controlling said state machines using said script; and
representing said characters and said objects on an output device by representing states of said state machine.

26. A method according to claim 25, wherein said script has a first track representing activities determined by said director and a second performance track to automatically add additional quasi-random physical motion of said characters.

27. A method according to claim 25, comprising identifying inconsistencies between activities in the first track and the quasi-random physical motion in the second track, and adjusting the quasi-random physical motion to inhibit said inconsistencies.

28. A method as claimed in claim 25 wherein a said state machine representing a character comprises a multithreaded state machine, each thread defining actions for a part of the character, the method animating between poses of each said character part, each said pose being represented by a state of said state machine.

29. A method according to claim 25, wherein at least one of said activities contains one or more sub-activities nested within said at least one activity and wherein said activities and sub-activities are stored in a set of hierarchical data containers.

30. A method as claimed in claim 25 wherein said data containers comprise time-referenced data items and wherein, when animating a said character, said data items are processed in time order substantially irrespective of a hierarchy of a said data container holding a said data item.

31. A method as claimed in claim 30 wherein said director is able to play said animation from a selected point in time and wherein, when jumping to a time inside a said container, animation of activities nested within said container is delegated to said container.

32. A method according to claim 25, wherein said director is able to define a series of goals for said characters such that said movie is at least in part generated by stepwise solving said series of goals.

33. A method according to claim 25, comprising applying the series of goals to identify inconsistencies between said physical configuration of said characters and said objects.

34. A method according to claim 31, further comprising flagging an error on the output device to notify said director of said inconsistencies.

35. A method according to claim 31, further comprising finding alternative solutions to the goals to remove said inconsistencies.

36-37. (canceled)

38. A method of providing random time access to a scripted animation, said animation being defined by animation of between configurations of characters and objects each defined by a state of a state machine, the method comprising identifying a defined state of said animation at a time prior to a random access time and then playing said animation forward from said prior time to said random access time.

39-40. (canceled)

41. A machine-readable medium comprising instructions for controlling a virtual camera position in a 3D virtual reality environment to enable a director controlling said environment to create a movie of a story set within said environment, the instructions when implemented by one or more processors perform the following method:
selecting a subject in said environment;
defining a framing line on said subject; and
wherein said framing line defines an image of said subject captured by said virtual camera and determines a position of said virtual camera relative to said subject, such that as said subject moves within said environment, said virtual camera moves with said subject so as to maintain substantially the same image of said subject captured by said virtual camera.
